(19) United States
(12) Patent Application Publication
(10) Pub. No.: US 2024/0111722 A1
(43) Pub. Date: Apr. 4, 2024

(54) BACKGROUND DELETION OF LARGE DIRECTORIES

(71) Applicant: VMware, Inc., Palo Alto, CA (US)

(72) Inventors: Xiaohua FAN, Shanghai (CN); Zhaohui GUO, Shanghai (CN); Wenguang WANG, Santa Clara, CA (US); Kiran PATIL, Freemont, CA (US); Abhay Kumar JAIN, Santa Clara, CA (US)

(21) Appl. No.: 18/057,384

(22) Filed: Nov. 21, 2022

(30) Foreign Application Priority Data
Oct. 3, 2022 (WO) PCT/CN2022/123682

(51) Int. Cl. G06F 16/16; G06F 16/185; G06F 16/188

(52) U.S. Cl. CPC G06F 16/162; G06F 16/185; G06F 16/188

(57) ABSTRACT

Deleting directories in a virtual distributed file system (VDFS), and non-virtual file systems, involves changing the name of a selected directory to a unique object identifier (UID) and moving the selected directory, named according to the UID, to a deletion target directory. A recursive process, implemented using a background deletion thread, starts in the current directory and identifies objects in the current directory. For an object that is a file or an empty directory, the object is added to a deletion queue. For an object that is a directory that is not empty, the recursion drops down into that directory as the new current directory. When the recursion has exhausted the selected directory, or some maximum object count has been reached, the objects identified in the deletion queue are deleted. This approach can also be used for file operations other than deletion, such as compression, encryption, and hashing.

### CROSS-REFERENCE TO RELATED APPLICATION

This application claims the benefit of International Application No. PCT/CN2022/123682 filed Oct. 3, 2022, the entirety of which is incorporated herein by reference.

### BACKGROUND

Fast, large scale file deletion is a common requirement of file system users, although common file system protocols prevent deleting non-empty directories. Traditionally, in order to delete a large directory, a file system client needs to recursively delete all files and subdirectories beneath it. Unfortunately, for distributed file systems, such as virtual distributed file systems (VDFSs), this is a time-consuming process due to the messaging required between file system clients and the file server.

Some virtualization scenarios involve creating and deleting thousands or millions of files on a daily basis. For example, when a build server is requested to build a project with a specific change number, the build server populates all source files of the project and begins the build. During the build, the server downloads required libraries and other components, creating a large number of intermediate files. After generating and persisting the binary packages, the build server performs a clean-up of the storage by deleting the directory containing the intermediate files. To delete a large directory with multiple deep layers, the client deletes all files and subdirectories within the main directory recursively. With typical network latencies, this is a slow and inefficient process.

Some existing approaches also require users, who are using a command-line interface (CLI), to have administrator privileges. This requirement either leads to tight limitations on who may delete large directories or poor security practices by granting administrator privileges to too many users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for deleting directories in a virtual distributed file system (VDFS) and other file systems. Solutions include: changing a name of a selected directory to a unique object identifier (UID); moving the selected directory, named according to the UID, to a deletion target directory; recursively, by a background deletion thread, for a current directory under the deletion target directory: identifying objects in the current directory; based on at least an object comprising a file, adding the file to a deletion queue; based on at least an object comprising an empty directory, adding the empty directory to the deletion queue; and based on at least an object comprising a directory that is not empty, setting the directory that is not empty to the current directory; and deleting the objects identified in the deletion queue.

### BRIEF DESCRIPTION OF THE DRAWINGS

The present description will be better understood from the following detailed description read in the light of the accompanying drawings, wherein:

FIG. 1 illustrates an example architecture that advantageously provides for background deletion of large directories;

FIG. 2 illustrates further detail for an example of an architecture that provides for background deletion of large directories;

FIG. 3 illustrates example recursion of directories;

FIG. 4 illustrates a flowchart of exemplary operations associated with background deletion of large directories;

FIG. 5 illustrates an example architecture which performs a generic file operation;

FIG. 6 illustrates a flowchart of exemplary operations associated with performing a generic file operation;

FIGS. 7A and 7B illustrate additional flowcharts of exemplary operations; and

FIG. 8 illustrates a block diagram of an example computing apparatus that may be used as a component of the architectures of FIGS. 1, 2, and 5.

Any of the figures may be combined into a single example or embodiment.

### DETAILED DESCRIPTION

Solutions delete directories in a virtual distributed file system (VDFS) and in non-virtual file systems. The name of a selected directory is changed to a unique object identifier (UID) and moved to a deletion target directory. The deletion target directory is a system directory, rather than a user-created directory, and moving the selected directory deletes the entirety of the directory and all of its contents, unless some files remain open. A file being open prevents its deletion and also the deletion of the directory structure above it. A recursive process, implemented using a background deletion thread, starts in the current directory and identifies objects in the current directory. For an object, of the identified objects, that is a file or an empty directory, the object is added to a deletion queue. For an object that is a directory that is not empty, the recursion drops down into that directory as the new current directory.

When the recursion has exhausted the selected directory, or some maximum object count has been reached, the objects identified in the deletion queue are deleted. This approach can be used for file operations other than deletion that recurse through directories, such as compression, encryption, and hashing. For some file operations, the selected directory name may not need to be changed to the UID.

Aspects of the disclosure reduce computing resources incurred by common processes, reduce power consumption, and improve efficiency. This reduces the number of physical computing devices needed to support a large VDFS. This is accomplished, at least in part, by a background deletion thread deleting objects identified in a deletion queue, after moving a selected directory named according to its UID to a deletion target directory. This precludes the need for a series of back-and-forth deletion messages to clear out each directory in the directory hierarchy. Thus, aspects of the disclosure provide a practical, useful result to solve a technical problem in the domain of computing.

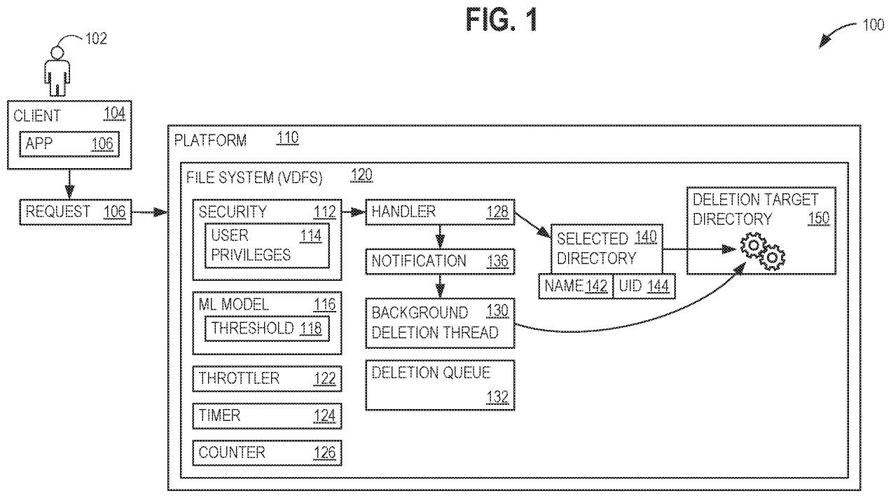

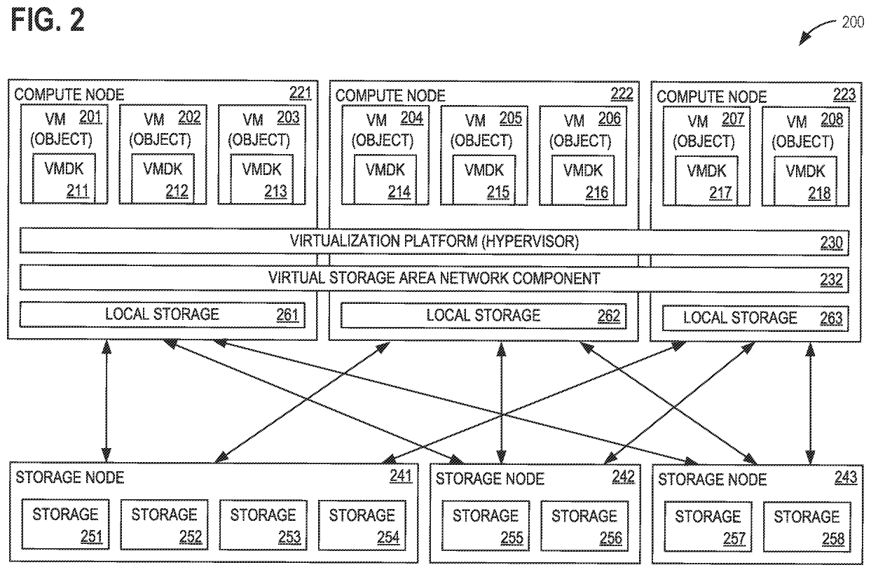

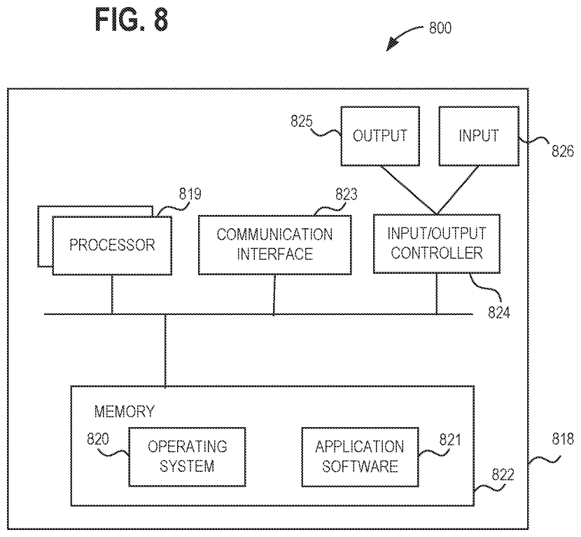

FIG. 1 illustrates an example architecture 100 that advantageously provides for background deletion of large directories. Architecture 100 uses a computing platform 110 which may be implemented on one or more computing apparatus 818 of FIG. 8, and/or using a virtualization architecture 200 as is illustrated in FIG. 2. A user 102 on a client 104 (e.g., a computing apparatus 818 local to user 102) wishes to delete a selected directory 140 from computing platform 110, which operates in a server role relative to client 104. Alternatively, an application (app) 106 is executing a task that involves automatically deleting selected directory 140, without intervention by user 102.

Selected directory 140 is stored within a file system 120, which may be a VDFS, a distributed file system, or a traditional file system native to a computing apparatus 818. Selected directory 140 has a name 142, which may have lexical significance to user 102, and a UID 144, which may appear random to user 102 and have little or no lexical significance. Whereas name 142 may have been selected in order to permit a human user to locate data and navigate within a complex directory structure, UID 144 was generated in a manner intended to minimize the likelihood that any other file or directory (or folder) on computing platform 110 will have the same identifier. For example, UID 144 may be a partial result of a hash value.

File system 120 also has a deletion target directory 150 for accepting objects in file system 120, such as files and directories, that are intended for deletion. A background deletion thread 130 deletes anything that is moved into deletion target directory 150. Background deletion thread 130 runs continuously as a background thread on computing platform 110. Thus, when a handler 128 moves selected directory 140 into deletion target directory 150, background deletion thread 130 deletes selected directory 140 and everything within selected directory 140, without requiring selected directory 140 to be empty. In some examples, handler 128 notifies background deletion thread 130 that something has been moved into deletion target directory 150 for deletion, using a notification 136. In some examples, background deletion thread 130 monitors deletion target directory 150 for new items and does not require external notification.

In operation, client 104 sends a move request 108 to file system 120, to move selected directory 140 into deletion target directory 150, based on input from user 102 or app 106. Because of the consequence of moving anything into deletion target directory 150, move request 108 is equivalent to, and interpreted as, an indication to delete selected directory 140. A security module 112 determines whether user 102 has, or app 106 is executing with, sufficient user privilege by checking user privileges 114. Absent sufficient privilege to delete selected directory 140, selected directory 140 is not moved to deletion target directory 150. Otherwise, if there is sufficient privilege to delete the top level of selected directory 140, security module 112 infers privilege to delete all objects within selected directory 140 (which includes all objects within the lower tier directories). Security module 112 alerts handler 128, which moves selected directory 140, and all objects within selected directory 140, to deletion target directory 150.

Background deletion thread 130 moves through all directories within (e.g., under) the top tier of selected directory 140 recursively, identifying files and directories for deletion in a deletion queue 132. Deletion queue 132 lists the objects (e.g., files and directories) for deletion. In some examples, the actual deletion of the objects begins after the recursion is complete. In some examples, the actual deletion of the objects begins while the recursion remains ongoing and executes in parallel until the recursion completes.

Because file operations, such as traversing directories to add objects to deletion queue 132 and the actual deletion itself, may be time consuming, it is possible that background deletion thread 130 may negatively impact the speed of other contemporaneous activities of file system 120. A throttler 122 compares the slowdown of file system 120 with a threshold 118, and if background deletion thread 130 causes file system 120 to slow down by a threshold amount, throttler 122 throttles background deletion thread 130, slowing it down in order to reduce the impact on the other contemporaneous activities of file system 120. A machine learning (ML) model 116 is used to set threshold 118. In some examples, throttler 122 itself includes an ML model.

A timer 124 is used to prevent background deletion thread 130 from beginning deletion operations too early after bootstrapping of file system 120. For example, background deletion thread 130 only begins recursing through selected directory 140 after a stabilization period determined using timer 124. In some scenarios, when selected directory 140 has an exceptionally large number of objects, deletion queue 132 may grow quite long. A counter 126 determines whether deletion queue 132 has reached a maximum count of entries. If so, background deletion thread 130 ceases recursing through selected directory 140 and adding more items to deletion queue 132, and instead deletes the objects identified in deletion queue 132. When deletion queue 132 is purged, background deletion thread 130 may resume recursing through selected directory 140 and adding items to deletion queue 132 again.

Examples of architecture 100 are operable with virtualized and non-virtualized storage solutions. FIG. 2 illustrates a virtualization architecture 200 that may be used as a version of computing platform 110. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines (VMs, such as base objects, linked clones, and independent clones), containers, applications, or any compute entity (e.g., computing instance or virtualized computing instance) that consumes storage. When objects are created, they may be designated as global or local, and the designation is stored in an attribute. For example, compute node 221 hosts objects 201, 202, and 203; compute node 222 hosts objects 204, 205, and 206; and compute node 223 hosts objects 207 and 208. Some of objects 201-208 may be local objects. In some examples, a single compute node may host 50, 100, or a different number of objects. Each object uses a VM disk (VMDK), for example VMDKs 211-218 for each of objects 201-208, respectively. Other implementations using different formats are also possible. A virtualization platform 230, which includes hypervisor functionality at one or more of compute nodes 221, 222, and 223, manages objects 201-208. In some examples, various components of virtualization architecture 200, for example compute nodes 221, 222, and 223, and storage nodes 241, 242, and 243 are implemented using one or more computing apparatus such as computing apparatus 818 of FIG. 8.

Virtualization software that provides software-defined storage (SDS), by pooling storage nodes across a cluster, creates a distributed, shared data store, for example a storage area network (SAN). Thus, objects 201-208 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 252, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-208 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201 and 202. Virtual SAN component 232 permits objects 201 and 202 to write incoming data from object 201 and incoming data from object 202 to storage nodes 241, 242, and/or 243, in part, by virtualizing the physical storage components of the storage nodes.

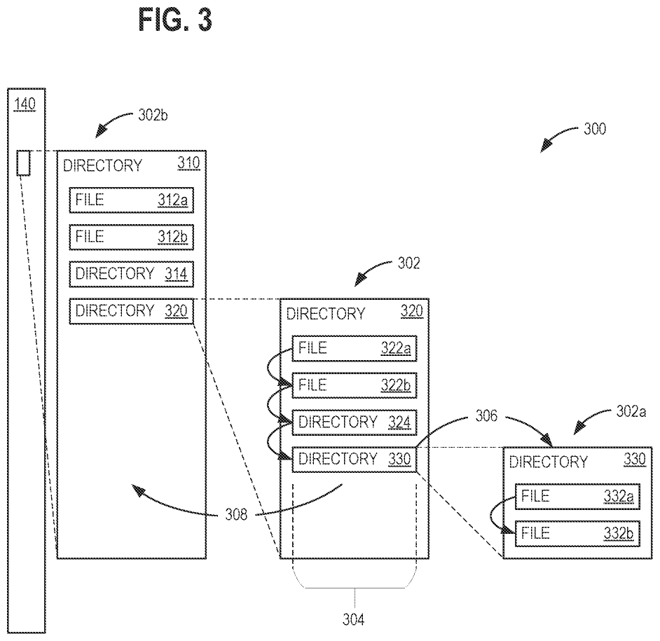

FIG. 3 illustrates recursion of directories, as may occur when using examples of architecture 100. In the illustration, a directory hierarchy 300 has a directory 310 under selected directory 140, a directory 320 under directory 310, and a directory 330 under directory 320. Directories 320 and 330 are also under selected directory 140, due to the hierarchical arrangement. The objects in each directory are either files or directories. Files may be open or not open (closed), and a directory may be either empty or not empty. An empty directory is one that has at least one object within that is not already identified on deletion queue 132. So a directory that has no objects is empty, and a directory that has objects that are all listed on deletion queue 132 already is also “empty” because deletion of those objects is pending.

At the illustrated point in time, the recursion has progressed such that directory 320 is the current directory 302. Current directory 302 is the directory in which the recursion is operating at the time. Objects 304 in current directory 300 include files 322a and 322b and directories 324 and 330. File 322a is added to deletion queue 132, however, file 322b is open, so it is skipped and not added to deletion queue 132. Directory 324 is empty and so is added to deletion queue 132, however, directory 330 is not yet empty. Thus the recursion drops down, following arrow 306, into directory 330, which becomes the new current directory 302a. A file 332a is added to deletion queue 132 and a file 332b is added to deletion queue 132, and directory 330 (new current directory 302a) is now exhausted.

The recursion moves back upward hierarchically, in the direction toward selected directory 140, and directory 320 is now the current directory 300 again. Directory 330 is now empty, because files 332a and 332b have both been added to deletion queue 132. Directory 330 is now added to deletion queue.

At this point, directory 320 is now exhausted, and the recursion again moves upward hierarchically, following arrow 308, into directory 310, which is now the current directory 300b again. A file 312a, a file 312b, and an empty directory 314 had already been added to deletion queue, before the recursion reached directory 320. Directory 320 is not empty, because open file 322b was not added to deletion queue 132. Thus, directory 320 is not added to deletion queue 132.

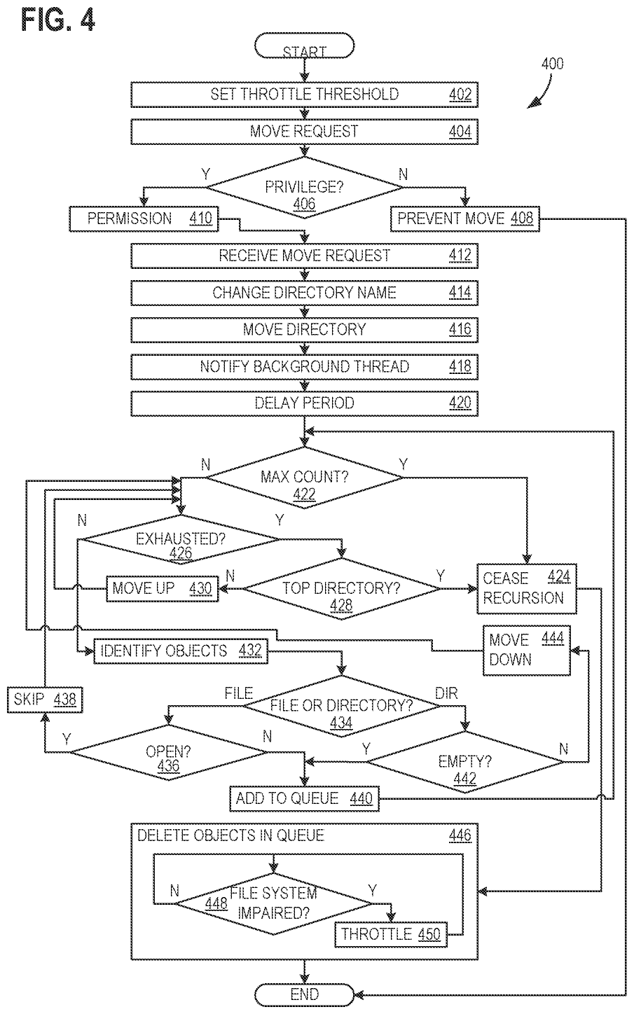

FIG. 4 illustrates a flowchart 400 of exemplary operations associated with architecture 100. In some examples, the operations of flowchart 400 are performed by one or more computing apparatus 818 of FIG. 8. Flowchart 400 commences with ML model 116 setting threshold 118 in operation 402. In operation 404, user 102 or app 106 on client 104 requests to move selected directory 140 in file system 120 to deletion target directory 150, with move request 108. Move request 108 comprises an indication to delete selected directory 140. Neither user 102 nor app 106 has administrator privileges, although they do have sufficient privileges to delete selected directory 140.

In decision operation 406, security module 112 determines whether user 102 or app 106, whichever sent move request 108, has privileges to delete selected directory 140. If not, based on at least user 102 or app 106 not having privileges to delete selected directory 140, operation 408 prevents selected directory 140 from moving to deletion target directory 150. Flowchart 400 then terminates. Otherwise, based on establishing user permission to delete selected directory 140, security module 112 infers permission to delete lower directories under selected directory 140 in operation 410.

Handler 128 receives move request 108 which is an indication to delete selected directory 140, in operation 412, and changes name 142 of selected directory 140 to UID 144 in operation 414. This prevents two objects within deletion target directory 150 from having the same name. Handler 128 then moves selected directory 140, named according to UID 144, to deletion target directory 150 in operation 416. In some examples, moving selected directory 140 to deletion target directory 150 comprises moving selected directory 140 to deletion target directory 150 based on at least user 102 or app 106 having privileges to delete selected directory 140. In operation 418, handler 128 notifies background deletion thread 130 to begin an asynchronous deletion process, and background deletion thread 130 receives the notification as notification 136. Operation 420 delays the asynchronous deletion process by any time remaining on a stabilization period, if necessary, as determined using timer 124. Decision operation 422 through operation 444, described below, are performed recursively by background deletion thread 130 for each current directory 302, until the directory hierarchy of selected directory 140 is fully traversed. At the start and end of the recursion, current directory 302 is selected directory 140, but traverses through the lower directories under selected directory 140. Decision operation 422 determines, using counter 126, whether deletion queue 132 has reached a maximum count of entries. If deletion queue 132 has reaching the maximum count of entries, operation 424 ceases the recursion, and flowchart 400 moves to operation 446, where objects identified (listed) in deletion queue 132 are deleted from file system 120.

Otherwise, flowchart 400 moves to decision operation 426, which determines whether current directory 302 is exhausted. Current directory 302 is exhausted when all objects within current directory have either been added to deletion queue 132, skipped because they are open files or, if they are non-empty directories, the recursion has already completed within them. If current directory 302 is exhausted, decision operation 428 determines whether the recursion has returned back to the top directory. This is the case when current directory 302 has returned, after recursion on the lower directories is completed, back to selected directory 140. If so, flowchart 400 moves to operation 424 and then operation 446. Otherwise, if the recursion has not returned to the top directory, then upon exhausting current directory 302, operation 430 moves upward hierarchically, a single directory, toward selected directory 140 and flowchart 400 returns to decision operation 426.

If, as determined by decision operation 426, current directory 302 is not exhausted, operation 432 identifies objects in current directory 302. Objects may be either files or directories, as determined by decision operation 434. If an object is a file, decision operation 436, determines whether the file is open. If the file is open, as was described for file 322b in relation to FIG. 3, it is skipped in operation 438 and not added to deletion queue 132. Flowchart 400 then returns to decision operation 426. Otherwise, if the file is not open, as was described for file 322a in relation to FIG. 3, it is added to deletion queue 132 in operation 440. Because deletion queue 132 has now grown (which did not occur when a file was skipped), flowchart 400 returns to decision operation 422.

If, however, the object is not a file but is instead a directory, decision operation 442 determines whether the directory is empty. An empty directory comprises a directory having no objects that are not identified in deletion queue 132. Based on at least the object comprising an empty directory, flowchart moves to operation 440, where empty directory 324 is add to deletion queue 132, before returning to decision operation 422.

Otherwise, if the directory is not empty, as determined in decision operation 442, operation 444 sets the directory 330 that is not empty to the new current directory 302 (or 302a, as illustrated in FIG. 3). The recursion then moves down into the new current directory, and flowchart 400 returns to decision operation 426. Flowchart 400 cycles from decision operation 426 through operation 444 until exiting the cycle via operation 424, either coming from decision operation 422 with the maximum count being reached, or from decision operation 428 when selected directory 140 has been thoroughly traversed.

Operation 446 deletes the objects identified in deletion queue 132 and includes decision operation 448 and operation 450. Decision operation 448 performs ongoing monitoring to determine whether background deletion thread 130 is impairing other operations of file system 120 by threshold 118, for example causing a slowdown. If impairment is identified, operation 450 throttles background deletion thread 130 to alleviate the impairment of file system 120.

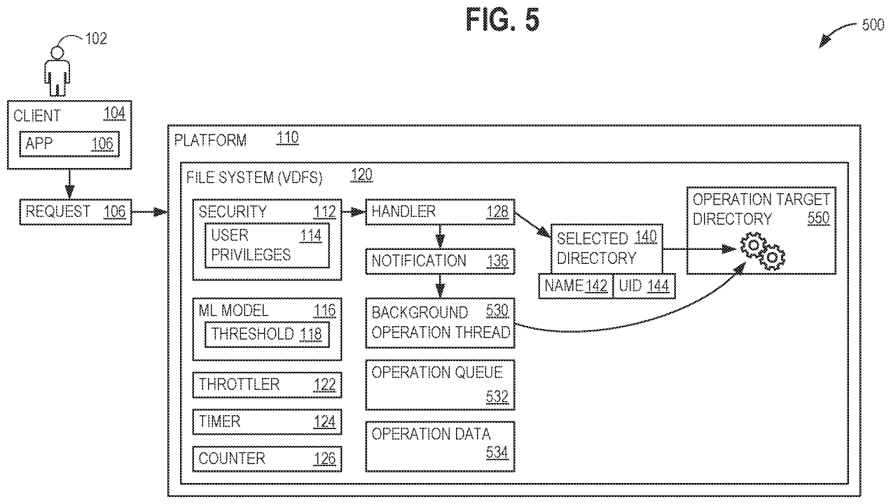

Architecture 100 may be abstracted for other directory-based file operations, in addition to deletion, such as compression, hashing, and encryption. FIG. 5 illustrates an abstracted version of architecture 100, in which the specific file operation of deletion is replaced with a reference to a generic file operation. The structure of architecture 100 remains intact in architecture 500, and when the generic file operation is focused on deletion, architecture 500 returns to architecture 100. As with architecture 100, file system 120 may be virtual or not virtual.

In architecture 500, background deletion thread 130 is replaced with background operation thread 530 that performs a file operation, which may be any of deletion, compression, hashing, encryption, permission change, or another file operation. For example, for an asynchronous tree permission change will change permission on a large directory and all the files and subdirectories within it. The file operation may be an asynchronous operation changes file and directory permissions recursively in in file system 120.

Deletion queue 132 is replaced by the more generic operation queue 532 and holds a list of objects upon which the file operation is to be performed. Deletion target directory 150 is replaced with operation target directory 550, which has an equivalent function of hosting selected directory 140 for the recursion and file operations. Operation target directory 550 is a system directory, rather than a user-created directory, and moving selected directory 140 results in the operation being performed on all of the files in selected directory 140, unless some files remain open. A file being open prevents the operation from being performed on that file.

Operation data 534 is introduced, which is used to store data used for the file operation performed by background operation thread 530, such as parameters, values, and identification of algorithms. For example, if the operation is compression or hashing, operation data 534 identifies which compression algorithm is to be used. If the file operation is encryption, operation data 534 may further provide key management functionality.

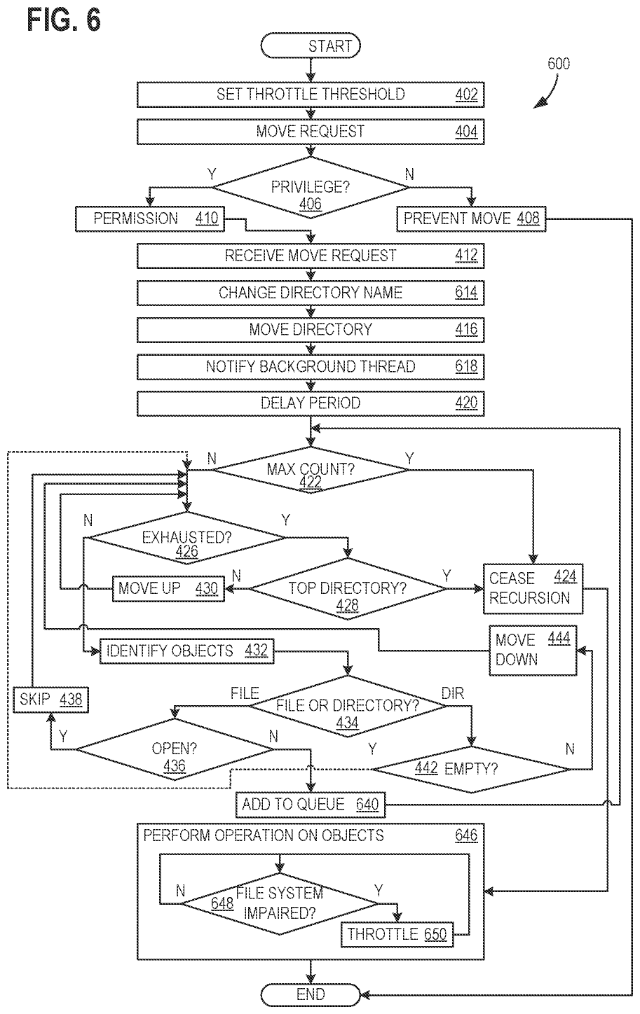

FIG. 6 illustrates a flowchart 600 of exemplary operations associated with architecture 500. In some examples, the operations of flowchart 600 are performed by one or more computing apparatus 818 of FIG. 8. Flowchart 600 largely tracks flowchart 400 of FIG. 4, and commonly-numbered operations operate in the same manner. The different operations are hereby described. For example, operation 414, which changes name 142 of selected directory 140 to UID 144 is changed to operation 614 in flowchart 600, to reflect that operation 614 is optional for some file operations other than deletion by a recursive process.

In operation 618, handler 128 notifies background operation thread 530 to begin the file operations, and background operation thread 530 receives the notification. Files that are not open are added to operation queue 532 in operation 640, and empty directories are also added to operation queue 532 at least when the file operation s deletion. When the file operation is compression, some compression algorithms may keep a stub for an empty directory, to preserve the hierarchy. However, for hashing and encryption, if decision operation 442 determines that the directory is empty, flowchart 600 instead returns to decision operation 426.

In operation 646, objects identified in operation queue 532 are subject to the file operation (which may be something other than deletion), and decision operation 648 and operation 650 monitor and throttle background operation thread 530.

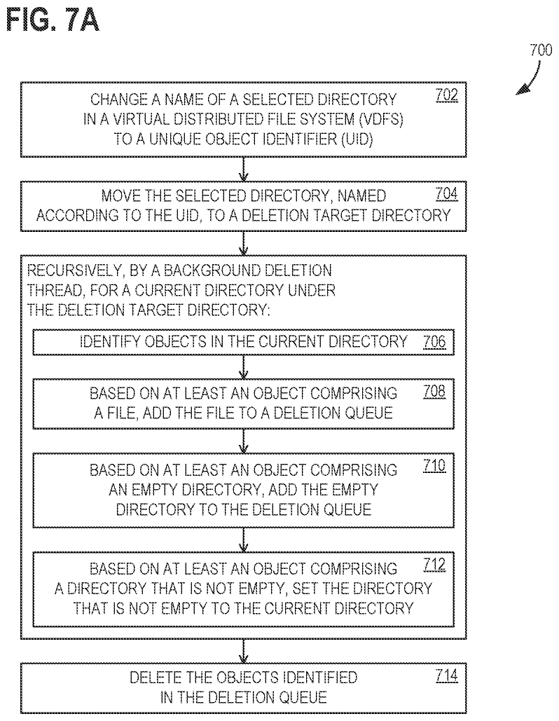

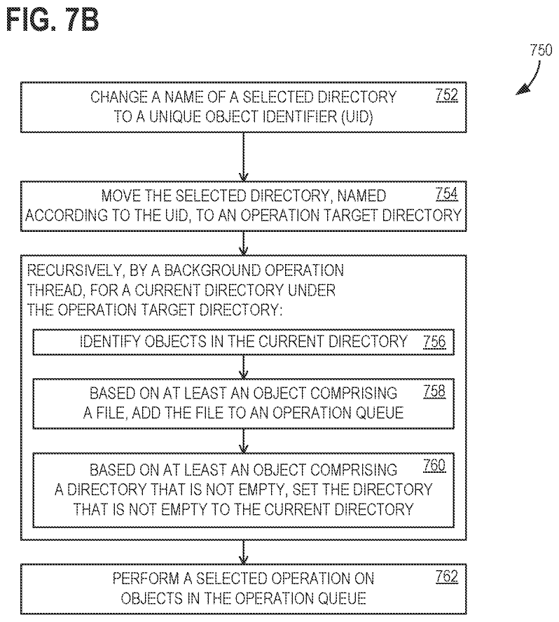

FIG. 7A illustrates a flowchart 700 of exemplary operations associated with architecture 100. In some examples, the operations of flowchart 700 are performed by one or more computing apparatus 818 of FIG. 8. Flowchart 700 commences with operation 702, which includes changing a name of a selected directory in a VDFS to a UID. Operation 704 includes moving the selected directory, named according to the UID, to a deletion target directory.

Operations 706-712 are performed recursively, by a background deletion thread, for a current directory under the deletion target directory. Operation 706 includes identifying objects in the current directory. Operation 708 includes, based on at least an object comprising a file, adding the file to a deletion queue. Operation 710 includes, based on at least an object comprising an empty directory, adding the empty directory to the deletion queue. Operation 712 includes, based on at least an object comprising a directory that is not empty, setting the directory that is not empty to the current directory. Operation 714 includes deleting the objects identified in the deletion queue.

FIG. 7B illustrates a flowchart 750 of exemplary operations associated with architecture 500 or architecture 100 (when the file operation is deletion). In some examples, the operations of flowchart 750 are performed by one or more computing apparatus 818 of FIG. 8. Flowchart 750 commences with operation 752, which includes changing a name of a selected directory to a UID. Operation 754 includes moving the selected directory, named according to the UID, to an operation target directory.

Operations 756-760 are performed recursively, by a background operation thread, for a current directory under the operation target directory. Operation 756 includes identifying objects in the current directory. Operation 758 includes, based on at least an object comprising a file, adding the file to an operation queue. Operation 760 includes, based on at least an object comprising a directory that is not empty, setting the directory that is not empty to the current directory. Operation 762 includes performing a selected operation on objects in the operation queue.

### Additional Examples

An example method of deleting directories in a VDFS comprises: changing a name of a selected directory to a UID; moving the selected directory, named according to the UID, to a deletion target directory; recursively, by a background deletion thread, for a current directory under the deletion target directory: identifying objects in the current directory; based on at least an object comprising a file, adding the file to a deletion queue; based on at least an object comprising an empty directory, adding the empty directory to the deletion queue; and based on at least an object comprising a directory that is not empty, setting the directory that is not empty to the current directory; and deleting the objects identified in the deletion queue.

An example computer system comprises: a processor; and a non-transitory computer readable medium having stored thereon program code executable by the processor, the program code causing the processor to: change a name of a selected directory in a VDFS to a UID; move the selected directory, named according to the UID, to a deletion target directory; recursively, by a background deletion thread, for a current directory under the deletion target directory: identify objects in the current directory; based on at least an object comprising a file, add the file to a deletion queue; based on at least an object comprising an empty directory, add the empty directory to the deletion queue; and based on at least an object comprising a directory that is not empty, set the directory that is not empty to the current directory; and delete the objects identified in the deletion queue.

An example non-transitory computer storage medium has stored thereon program code executable by a processor, the program code embodying a method comprising: changing a name of a selected directory in a VDFS to a UID; moving the selected directory, named according to the UID, to a deletion target directory; recursively, by a background deletion thread, for a current directory under the deletion target directory: identifying objects in the current directory; based on at least an object comprising a file, adding the file to a deletion queue; based on at least an object comprising an empty directory, adding the empty directory to the deletion queue; and based on at least an object comprising a directory that is not empty, setting the directory that is not empty to the current directory; and deleting the objects identified in the deletion queue.

An example method of performing file operations by directory comprises: changing a name of a selected directory to a UID; moving the selected directory, named according to the UID, to an operation target directory; recursively, by a background operation thread, for a current directory under the operation target directory: identifying objects in the current directory; based on at least an object comprising a file, adding the file to an operation queue; and based on at least an object comprising a directory that is not empty, setting the directory that is not empty to the current directory; and performing a selected operation on objects in the operation queue.

Another example computer system comprises: a processor; and a non-transitory computer readable medium having stored thereon program code executable by the processor, the program code causing the processor to perform a method disclosed herein. Another example non-transitory computer storage medium has stored thereon program code executable by a processor, the program code embodying a method disclosed herein.

Alternatively, or in addition to the other examples described herein, examples include any combination of the following:
based on at least an object comprising a file, determining whether the file is open;
adding the file to the deletion queue comprises adding the file to the deletion queue based on at least the file not being open;
based on at least the file being open, not adding the file to the deletion queue;
upon exhausting the current directory, moving upward hierarchically toward the selected directory;
determining whether a user selecting the selected directory for deletion has privileges to delete the selected directory;
the user does not have administrator privileges;
moving the selected directory to the deletion target directory comprises moving the selected directory to the deletion target directory based on at least the user having privileges to delete the selected directory;
based on at least the user not having privileges to delete the selected directory, preventing the user from moving the selected directory to the deletion target directory;
a request to move the selected directory to the deletion target directory comprises an indication to delete the selected directory;
determining whether the background deletion thread is impairing other operations of the VDFS by a threshold amount;
based on at least the background deletion thread impairing other operations of the VDFS by the threshold amount, throttling the background deletion thread;
setting the threshold amount with an ML model;
receiving, by a handler, the indication to delete the selected directory;
notifying, by the handler, the background deletion thread to begin an asynchronous deletion process;
receiving a notification, by the background deletion thread, to begin the asynchronous deletion process;
delaying, by a stabilization period, the asynchronous deletion process;
determining whether the deletion queue has reached a maximum count of entries;
based on at least the deletion queue reaching the maximum count of entries, ceasing the recursion;
based on establishing user permission to delete the selected directory, inferring permission to delete lower directories under the selected directory;
an empty directory comprises a directory having no objects that are not identified in the deletion queue;
the selected operation comprises deletion;
the selected operation comprises hashing;
the selected operation comprises encryption;
the selected operation comprises compression;
the selected operation comprises a permission change;
the selected operation is asynchronous;
based on at least an object comprising an empty directory, adding the empty directory to the operation queue;
based on at least an object comprising a file, determining whether the file is open, wherein adding the file to the deletion queue comprises adding the file to the operation queue based on at least the file not being open;
based on at least the file being open, not adding the file to the operation queue;
determining whether a user selecting the selected directory has privileges to perform the operation on the selected directory;
moving the selected directory to the operation target directory comprises moving the selected directory to the operation target directory based on at least the user having privileges to perform the operation on the selected directory;
based on at least the user not having privileges to perform the operation on the selected directory, preventing the user from moving the selected directory to the operation target directory;
a request to move the selected directory to the deletion target directory comprises an indication to perform the operation on the selected directory;
receiving, by a handler, the indication to perform the operation on the selected directory;
notifying, by the handler, the background operation thread to begin an asynchronous process to perform the process;
receiving a notification, by the background operation thread, to begin the asynchronous process;
delaying, by a stabilization period, the asynchronous process;
determining whether the operation queue has reached a maximum count of entries;
based on at least the operation queue reaching the maximum count of entries, ceasing the recursion; and
based on establishing user permission to perform the operation on the selected directory, inferring permission to perform the operation on lower directories under the selected directory.

### Exemplary Operating Environment

The present disclosure is operable with a computing device (computing apparatus) according to an embodiment shown as a functional block diagram 800 in FIG. 8. In an embodiment, components of a computing apparatus 818 may be implemented as part of an electronic device according to one or more embodiments described in this specification. The computing apparatus 818 comprises one or more processors 819 which may be microprocessors, controllers, or any other suitable type of processors for processing computer executable instructions to control the operation of the electronic device. Alternatively, or in addition, the processor 819 is any technology capable of executing logic or instructions, such as a hardcoded machine. Platform software comprising an operating system 820 or any other suitable platform software may be provided on the computing apparatus 818 to enable application software 821 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 818. Computer-readable media may include, for example, computer storage media such as a memory 822 and communications media. Computer storage media, such as a memory 822, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e.g., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 822) is shown within the computing apparatus 818, it will be appreciated by a person skilled in the art, that the storage may be distributed or located remotely and accessed via a network or other communication link (e.g., using a communication interface 823). Computer storage media are tangible, non-transitory, and are mutually exclusive to communication media.

The computing apparatus 818 may comprise an input/output controller 824 configured to output information to one or more output devices 825, for example a display or a speaker, which may be separate from or integral to the electronic device. The input/output controller 824 may also be configured to receive and process an input from one or more input devices 826, for example, a keyboard, a microphone, or a touchpad. In one embodiment, the output device 825 may also act as the input device. An example of such a device may be a touch sensitive display. The input/output controller 824 may also output data to devices other than the output device, e.g., a locally connected printing device. In some embodiments, a user may provide input to the input device(s) 826 and/or receive output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of deleting directories in a virtual distributed file system (VDFS), the method comprising:
changing a name of a selected directory to a unique object identifier (UID);
moving the selected directory, named according to the UID, to a deletion target directory;
recursively, by a background deletion thread, for a current directory under the deletion target directory:
identifying one or more objects in the current directory;
based on at least an object of the one or more objects comprising a file, adding the file to a deletion queue;
based on at least an object of the one or more objects comprising an empty directory, adding the empty directory to the deletion queue; and
based on at least an object of the one or more objects comprising a directory that is not empty, setting the directory that is not empty to the current directory; and
deleting the objects identified in the deletion queue.

2. The method of claim 1, further comprising:
based on at least an object of the one or more objects comprising a file, determining whether the file is open, wherein adding the file to the deletion queue comprises adding the file to the deletion queue based on at least the file not being open; and
based on at least the file being open, not adding the file to the deletion queue.

3. The method of claim 1, further comprising:
upon exhausting the current directory, moving upward hierarchically toward the selected directory.

4. The method of claim 1, further comprising:
determining whether a user selecting the selected directory for deletion has privileges to delete the selected directory, wherein the user does not have administrator privileges, and wherein moving the selected directory to the deletion target directory comprises moving the selected directory to the deletion target directory based on at least the user having privileges to delete the selected directory; and
based on at least the user not having privileges to delete the selected directory, preventing the user from moving the selected directory to the deletion target directory.

5. The method of claim 1, wherein a request to move the selected directory to the deletion target directory comprises an indication to delete the selected directory.

6. The method of claim 1, further comprising:
determining whether the background deletion thread is impairing other operations of the VDFS by a threshold amount; and
based on at least the background deletion thread impairing other operations of the VDFS by the threshold amount, throttling the background deletion thread.

7. The method of claim 6, further comprising:
setting the threshold amount with a machine learning (ML) model.

8. A computer system comprising:
a processor; and
a non-transitory computer readable medium having stored thereon program code executable by the processor, the program code causing the processor to:
change a name of a selected directory in a virtual distributed file system (VDFS) to a unique object identifier (UID);
move the selected directory, named according to the UID, to a deletion target directory;
recursively, by a background deletion thread, for a current directory under the deletion target directory:
identify one or more objects in the current directory;
based on at least an object of the one or more objects comprising a file, add the file to a deletion queue;
based on at least an object of the one or more objects comprising an empty directory, add the empty directory to the deletion queue; and
based on at least an object of the one or more objects comprising a directory that is not empty, set the directory that is not empty to the current directory; and
delete the objects identified in the deletion queue.

9. The computer system of claim 8, wherein the program code is further operative to:
based on at least an object of the one or more objects comprising a file, determine whether the file is open, wherein adding the file to the deletion queue comprises adding the file to the deletion queue based on at least the file not being open; and
based on at least the file being open, not add the file to the deletion queue.

10. The computer system of claim 8, wherein the program code is further operative to:
upon exhausting the current directory, move upward hierarchically toward the selected directory.

11. The computer system of claim 8, wherein the program code is further operative to:
determine whether a user selecting the selected directory for deletion has privileges to delete the selected directory, wherein the user does not have administrator privileges, and wherein moving the selected directory to the deletion target directory comprises moving the selected directory to the deletion target directory based on at least the user having privileges to delete the selected directory; and
based on at least the user not having privileges to delete the selected directory, prevent the user from moving the selected directory to the deletion target directory.

12. The computer system of claim 8, wherein a request to move the selected directory to the deletion target directory comprises an indication to delete the selected directory.

13. The computer system of claim 8, wherein the program code is further operative to:
determine whether the background deletion thread is impairing other operations of the VDFS by a threshold amount; and
based on at least the background deletion thread impairing other operations of the VDFS by the threshold amount, throttle the background deletion thread.

14. The computer system of claim 13 wherein the program code is further operative to:
set the threshold amount with a machine learning (ML) model.

15. A non-transitory computer storage medium having stored thereon program code executable by a processor, the program code embodying a method comprising:
changing a name of a selected directory to a unique identifier (UID);
moving the selected directory, named according to the UID, to an operation target directory;
recursively, by a background operation thread, for objects in a current directory under the operation target directory:
identifying an object in the current directory;
based on at least the object comprising a file, adding the file to an operation queue; and
based on at least the object comprising a directory that is not empty, setting the directory that is not empty to the current directory; and
performing a selected operation on objects in the operation queue, wherein the selected operation comprises one or more of the following: deletion, hashing, encryption, compression, a permission change.

16. The computer storage medium of claim 15, wherein the selected operation comprises deletion and the object comprises a file, and wherein the program code further comprises:
determining that the file is not open; and
adding the file to the operation queue.

17. The computer storage medium of claim 15, wherein the selected operation comprises deletion and the object comprises a file, and wherein the program code further comprises:
determine that the file is open; and
continuing the recursion with another of the objects without adding the file to the operation queue.

18. The computer storage medium of claim 15, wherein a request to move the selected directory to the operation target directory comprises an indication to perform the selected operation.

19. The computer storage medium of claim 15, wherein the program code method further comprises:
determining whether the background operation thread is impairing other operations of a virtual distributed file system (VDFS) by a threshold amount; and
based on at least the background operation thread impairing other operations of the VDFS by the threshold amount, throttling the background operation thread.

20. The computer storage medium of claim 15, wherein the program code method further comprises:
determining whether the operation queue has reached a maximum count of entries; and
based on at least the operation queue reaching the maximum count of entries, ceasing the recursion.
